(19) United States
(12) Patent Application Publication
(10) Pub. No.: US 2012/0089241 A1
(43) Pub. Date: Apr. 12, 2012

(54) ELECTRONIC DEVICE AND METHOD FOR SIMULATING PROBE OF WORKPIECE MEASURING DEVICE

(75) Inventors: CHIH-KUANG CHANG, Tu-Cheng (TW); XIN-YUAN WU, Shenzhen City (CN); WEI WANG, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/187,527

(22) Filed: Jul. 21, 2011

(30) Foreign Application Priority Data
Oct. 6, 2010 (CN) 201010299023.9

(51) Int. Cl. G06F 17/50; G06F 19/00

(52) U.S. Cl. 700/98

(57) ABSTRACT

A method simulates a probe of a workpiece measuring device using an electronic device. The electronic device correlates component names of the probe to a corresponding CAD modeling file, reads the CAD modeling files from a first file according to a drawing order of the probe, and draws a three-dimensional (3D) model of the probe according to the drawing order and the relative positions between each two components. The first file includes specifications of components of the probe, the component names, file names of computer aided design (CAD) modeling files of the components, and relative positions between each two components. After controlling the 3D model to simulate the probe measuring the measurement points, and a measurement path is displayed on a display screen.

### BACKGROUND

1. Technical Field

Embodiments of the present disclosure generally relate to workpiece measuring devices and methods, particularly to an electronic device and method for simulating a probe of a workpiece measuring device.

2. Description of Related Art

In an automated process, workpieces on a production line should be carefully measured to ensure all dimensions of the workpieces are within predetermined tolerances. This process may be automated using a device with a probe to check several points of the workpieces. To determine a path for the probe to check the various points of the workpiece, 3D images of the probe and an ideal model of the workpiece should be programmed into simulation software. However, current simulation methods have many shortcomings. Once a successful simulation has been performed and a path determined for the probe and is put to use the data of the path is not viewable and a current position cannot be verified by an operator, and without real time monitoring of the path, collisions not predicted by the simulation cannot be easily avoided. Furthermore, should the probe need to be replaced, much additional work is needed because all details of the probe and a new 3D model of the probe must be reprogrammed, which is a costly use of time. Therefore, an improved simulation system and method is desirable to address the aforementioned issues.

### BRIEF DESCRIPTION OF THE DRAWINGS

FIG. 1 is a block diagram of one embodiment of an electronic device including a simulation unit.

FIG. 2 is a flowchart illustrating one embodiment of a method for simulating a probe of a workpiece measuring device.

FIG. 3 is a detailed description of block S03 in FIG. 2, namely triangulating 3D model of a probe.

FIG. 4 and FIG. 5 are schematic diagrams illustrating one exemplary of meshing the 3D model in FIG. 3 by a plurality of triangles.

FIG. 6 is a schematic diagram illustrating one exemplary of merging triangles between adjacent regions together.

FIG. 7 illustrates simulating measurement of a probe and drawing a measurement path.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

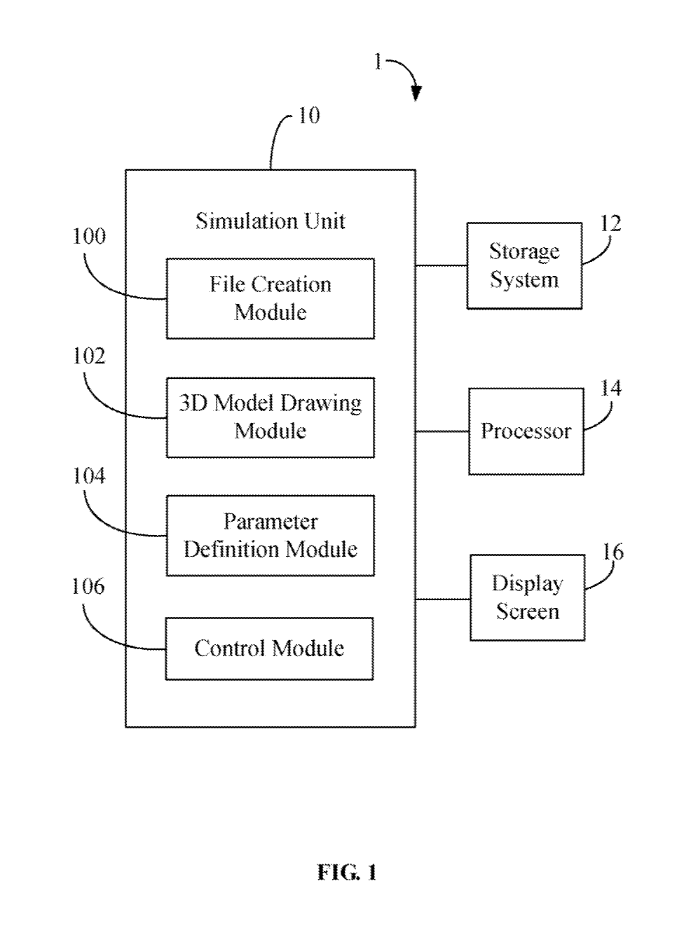

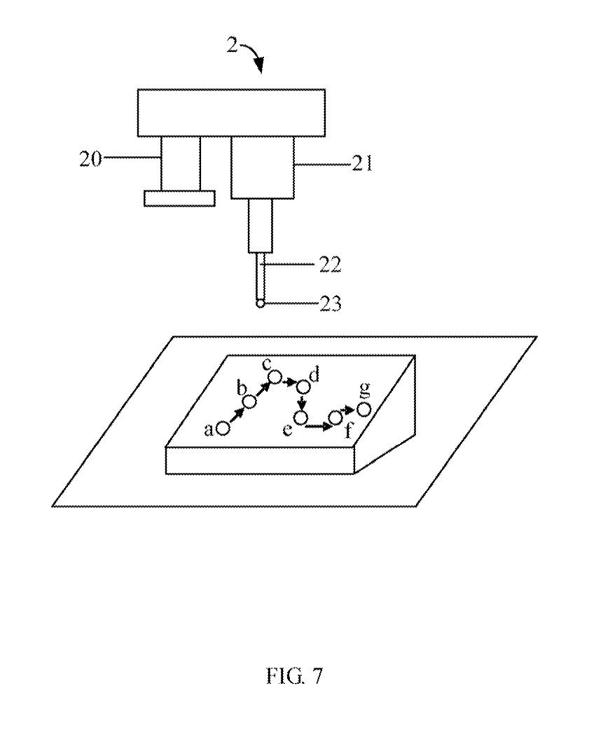

FIG. 1 is a block diagram of one embodiment of an electronic device 1 including a simulation unit 10. In the embodiment, functions of the simulation unit 10 are implemented by the electronic device 1. The simulation unit 10 can simulate a probe 2 (as shown in FIG. 7) of a workpiece measuring device to measure dimensions and/or boundaries of a workpiece 3, and display a measurement path on a display screen 16 of the electronic device 1.

In one embodiment, the electronic device 1 may be a computer, a server, a portable electronic device, or any other electronic device that includes a storage system 12, at least one processor 14, and the display screen 16.

In one embodiment, the simulation unit 10 includes a file creation module 100, a 3D model drawing module 102, a parameter definition module 104, and a control module 106. Each of the modules 100-106 may be a software program including one or more computerized instructions that are stored in the storage system 12 and executed by the processor 14. The processor may be a central processing unit or a math coprocessor, for example.

In one embodiment, the storage system 12 may be a magnetic or an optical storage system, such as a hard disk drive, an optical drive, a compact disc, a digital video disc, a tape drive, or other suitable storage medium.

The file creation module 100 creates a first file that stores specifications of components of the probe 2, component names, file names of computer aided design (CAD) modeling files of the components, and relative positions between each two components, and then correlates each of the component names to its CAD modeling file. Correlation, in one example, is defined as relating/correlating a component name of the probe 2 to a name of a CAD modeling file. For example, the file creation module 100 can correlate the component name “PROBEPH” to its CAD modeling file “PROBEPH.igs”.

As illustrated in FIG. 7, the components of the probe 2 may include a charge-coupled device (CCD) 20, a supported end 21, and a free end 22 having a work piece-contacting tip 23.

The 3D model drawing module 102 saves the component names in the order to be drawn (hereinafter referred to as “drawing order”) in a second file. The 3D model drawing module 102 further reads the CAD modeling files corresponding to the component names in the second file from the first file according to the drawing order, and draws a three-dimensional (3D) model of the probe 2 according to the relative position of each two components. In detail, the 3D model drawing module 102 combines the read CAD modeling files into an integrated graphic according to the drawing order. The integrated graphic is the 3D model of the probe 2, and can be saved in the second file.

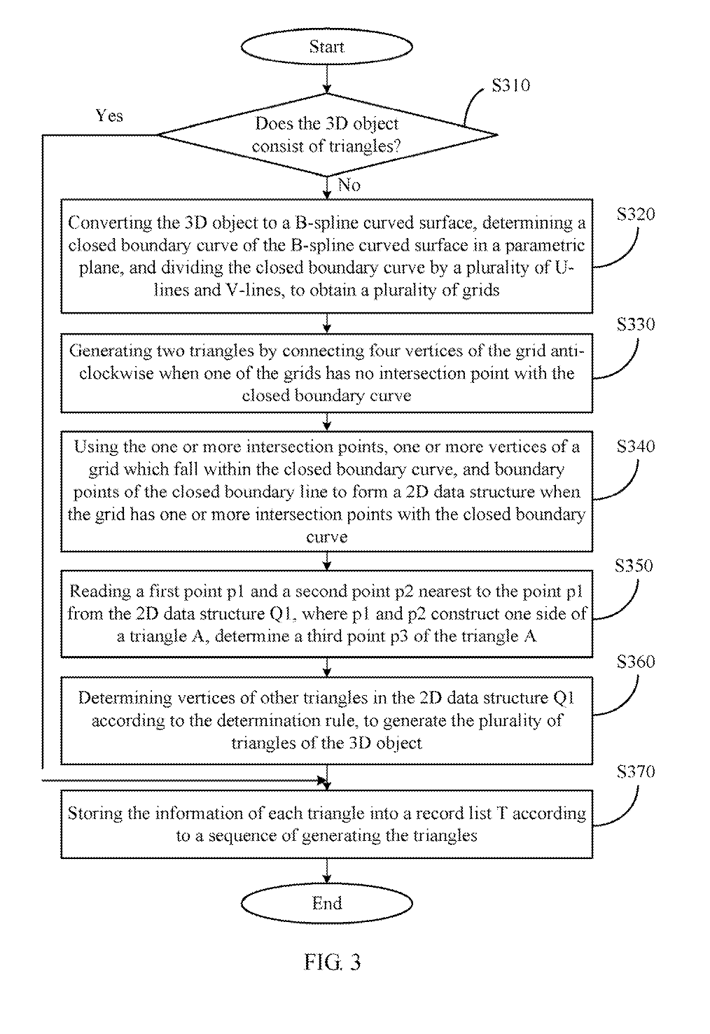

In the embodiment, the 3D model drawing module 102 is further operable to mesh the 3D model by a plurality of triangles, namely representing the 3D model by a plurality of triangles. Details of the mesh method are shown in FIG. 3. In one embodiment, the predetermined angle can be thirty degrees. In order to lessen the second file and enhance reading speed, and the 3D model drawing module 102 further merges the triangles in near regions together, upon the condition that a difference between normal vectors of the merged triangles is less than a predetermined angle, such as thirty degrees.

Before simulating the probe 2 measuring the workpiece, the parameter definition module 104 defines motion parameters of the 3D model of the probe 2. The motion parameters include a range of rotation, a range of motion, and a step length of the probe 2. In the embodiment, the probe 2 can move along any of an X-axis, a Y-axis, and a Z-axis. Since the probe 2 can rotate about either a horizontal axis or a vertical axis, the range of rotation includes a horizontal range and a vertical range, the horizontal range, in one example, can be [−180°, +180°], and the vertical range is [0°, 105°].

The control module 106 obtains measurement points of the workpiece from the storage system 12 in a preset order, and saves coordinate values of the measurement points in an array according to the preset order. The control module 106 further controls the 3D model to simulate the probe 2 measuring the measurement points in the array according to the motion parameters, and obtains a measurement path. The control module 106 draws the measurement path and displays the measurement path on the display screen 16. As shown in FIG. 7, a measurement path from point “a” to point “f” is illustrated.

In the embodiment, the first file, the second file, and the motion parameters can be saved in the storage system 12.

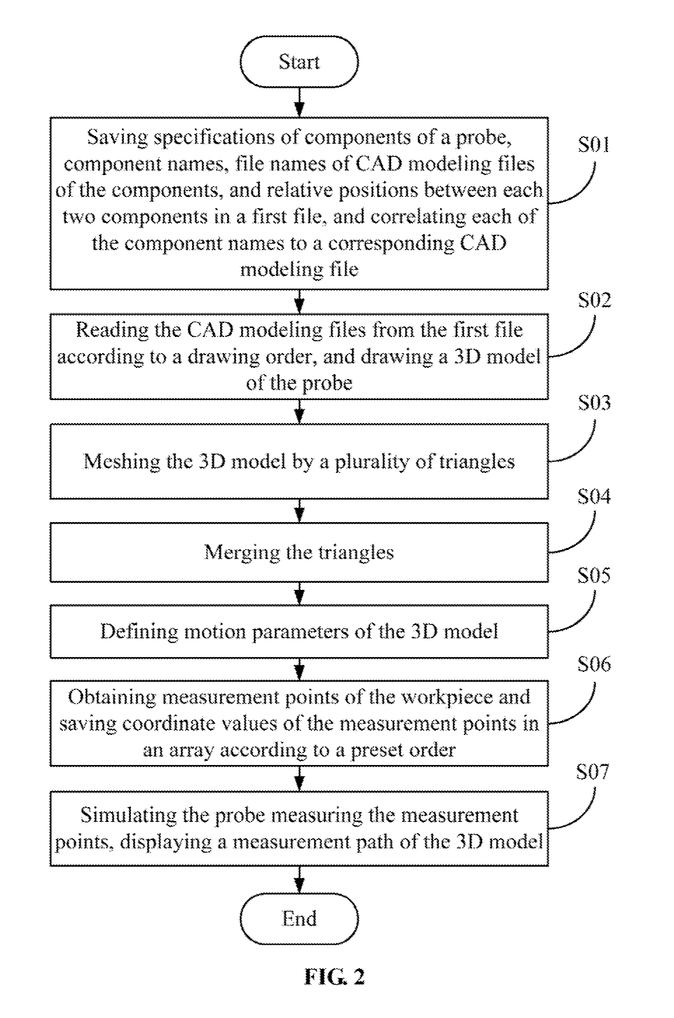

FIG. 2 is a flowchart illustrating one embodiment of a method for simulating a probe of a workpiece measuring device. Depending on the embodiment, additional blocks may be added, others removed, and the ordering of the blocks may be changed.

In block S01, the file creation module 100 creates a first file for storing specifications of components of the probe 2, component names, file names of CAD modeling files of the components, and relative positions between each two components, and correlates each of the component names to its CAD modeling file. Correlation, in one example, is defined as relating/correlating a component name of the probe 2 to a name of a CAD modeling file. For example, the file creation module 100 can correlate the component name “PROBEPH” to its CAD modeling file “PROBEPH.igs”.

In block S02, the 3D model drawing module 102 saves the component names in a second file according to a drawing order of the probe 2. After reading the CAD modeling files corresponding to the component names in the second file from the first file, the 3D model drawing module 102 draws a three-dimensional (3D) model of the probe 2 according to the relative positions between each two components.

In block S03, the 3D model drawing module 102 meshes the 3D model of the probe 2 by a plurality of triangles. Details of the mesh method are shown in FIG. 3 as follows.

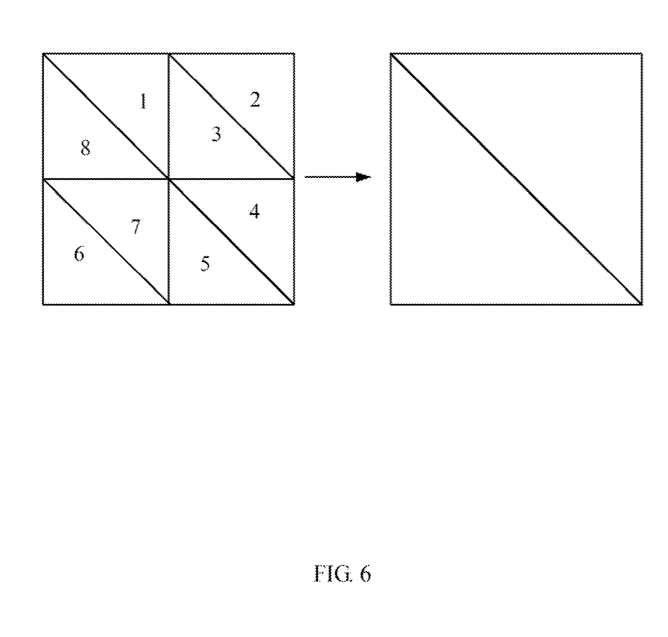

In block S04, the 3D model drawing module 102 merges the triangles between adjacent regions together for lessening the second file and enhancing reading speed. In one embodiment, a difference between normal vectors of the merged triangles is less than a predetermined angle, such as 30°. As shown in FIG. 6, the 3D model drawing module 102 merges the triangles “1,” “2,” “3,” and “4” to one triangle, and merges the triangles “5,” “6,” “7,” and “8” to another triangle.

In block S05, the parameter definition module 104 defines motion parameters of the 3D model of the probe 2. The motion parameters include a range of rotation, a range of motion, and a step length of the probe 2. In the embodiment, the probe 2 can move along any of an X-axis, a Y-axis, and a Z-axis. Since the probe 2 can rotate about either a horizontal axis or a vertical axis, the range of rotation includes a horizontal range and a vertical range, in one example, the horizontal range can be [−180°, +180°], and the vertical range can be [0°, 105°]

In block S06, the control module 106 obtains measurement points of the workpiece from the storage system 12 in a preset order, and saves coordinate values of the measurement points in an array according to the preset order.

In block S07, the control module 106 controls the 3D model to simulate the probe 2 measuring the measurement points in the array according to the motion parameters, and obtains a measurement path. The control module 106 draws the measurement path and displays the measurement path on the display screen 16. As shown in FIG. 7, a measurement path from point “a” to point “f” is illustrated.

FIG. 3 is a detailed description of block S03 in FIG. 2, namely meshing the 3D model of the probe 2 by a plurality of triangles. Depending on the embodiment, additional blocks may be added, others removed, and the ordering of the blocks may be changed.

In block S310, the 3D model drawing module 102 reads the 3D model from the second file, and determines if the 3D object consists of triangles. If the 3D object consists of triangles, the procedure directly goes to S370. Otherwise, if the 3D object does not consist of triangles, the procedure goes to block S320.

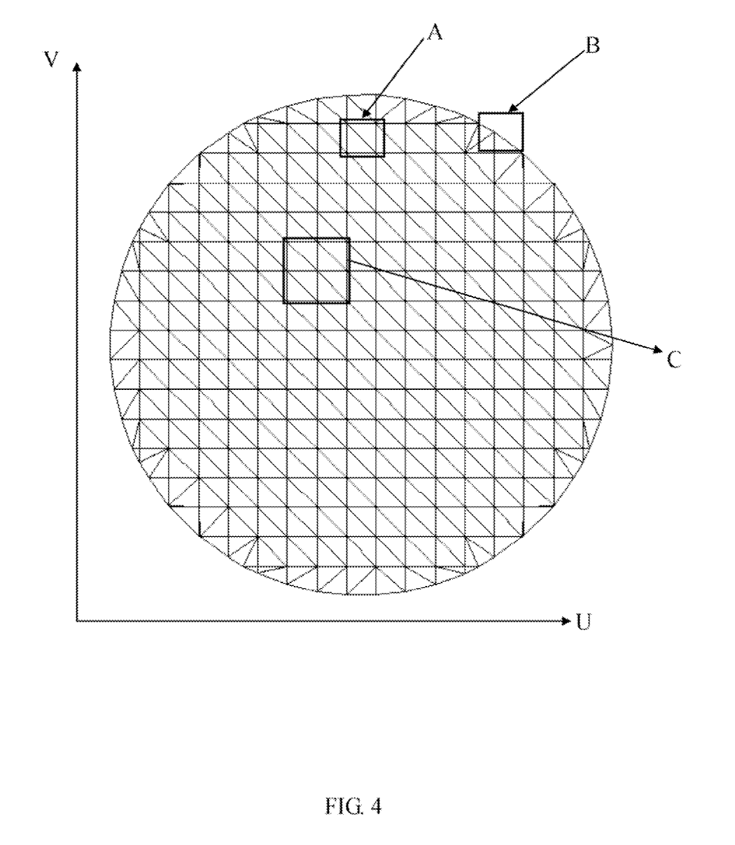

In block S320, the 3D model drawing module 102 converts the 3D object to a B-spline curved surface, and determines a closed boundary curve of the B-spline curved surface in a parametric plane. The 3D model drawing module 102 further divides the closed boundary curve to obtain a plurality of grids (as shown in FIG. 4) using a plurality of horizontal lines (hereinafter referred to “U-lines”) and vertical lines (hereinafter referred to “V-lines”).

In block S330, the 3D model drawing module 102 generates two triangles by connecting four vertices of the grid anti-clockwise when one of the grids has no intersection point with the closed boundary curve. For example, as shown in FIG. 8, four vertices “P,” “Q,” “I,” and “O” of a grid “box4” all fall within the closed boundary curve L1, then the 3D model drawing module 102 generates two triangles “OQP” and “OIQ” by connecting the four vertices “P,” “Q,” “I,” and “O” anti-clockwise.

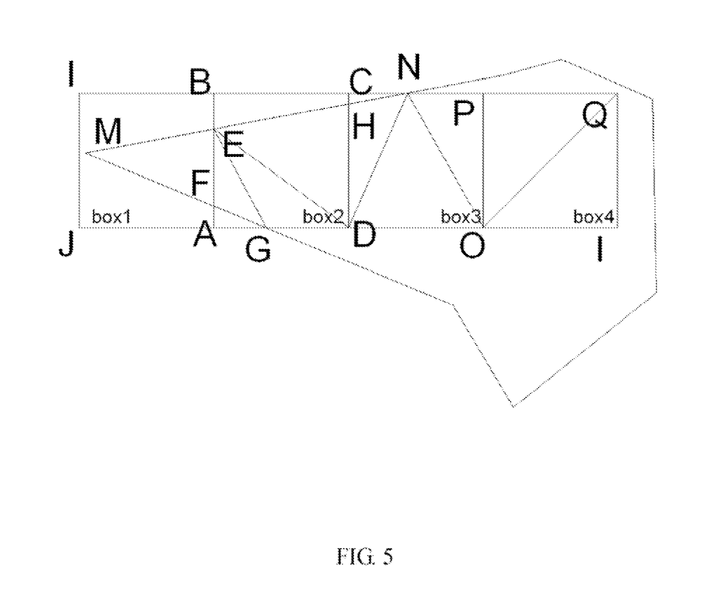

In block S340, the 3D model drawing module 102 uses the one or more intersection points, one or more vertices of a grid which fall within the closed boundary curve, and boundary points of the closed boundary line to form a two-dimensional (2D) data structure Q1, when the grid has one or more intersection points with the closed boundary curve (i.e., boxes “A” and “C” in FIG. 4). For example, as shown in FIG. 5, a boundary point “M” falls in a grid “box1,” and the grid “box1” has two intersection points “E” and “F” with the closed boundary curve L1. A vertex “D” of a grid “box2” falls within the closed boundary curve L1, and the grid “box2” has four vertices “E,” “F,” “C,” and “G” with the closed boundary curve L1. Then, the meshing module 11 uses the points “M,” “E,” “F,” “C,” “D,” and “G” to form the 2D data structure Q1.

In block S350, the 3D model drawing module 102 reads a first point p1 and a second point p2 nearest to the point p1 from the 2D data structure Q1, where p1 and p2 construct one side of a triangle A (i.e., box “B” in FIG. 4). The 3D model drawing module 102 further determines a third point p3 of the triangle A according to a determination rule that there is no 2D point of the 2D data structure Q1 in a circumcircle of the triangle A consisting of the points p1, p2, and p3.

In block S360, the 3D model drawing module 102 determines vertices of other triangles in the 2D data structure Q1 according to the determination rule, to generate the plurality of triangles of the 3D object.

In block S370, the 3D model drawing module 102 stores the information of each triangle into a record list T according to a sequence of generating the triangles.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for simulating a probe of a workpiece measuring device to measure a workpiece using an electronic device, the method comprising:
correlating component names of the probe to a corresponding CAD modeling file;
reading the CAD modeling files from a first file according to a drawing order of the probe, and drawing a three-dimensional (3D) model of the probe according to the drawing order and the relative positions between each two components, the first file comprising specifications of components of the probe, the component names, file names of computer aided design (CAD) modeling files of the components, and relative positions between each two components;
reading measurement points of the workpiece in a preset order, and saving coordinate values of the measurement points in an array according to the preset order;
obtaining a measurement path of the 3D model by controlling the 3D model to simulate the probe measuring the measurement points in the array according to predefined motion parameters; and
displaying the measurement path on a display screen of the electronic device.

2. The method as described in claim 1, further comprising:
(a) meshing the 3D model of the probe by a plurality of triangles; and
(b) merging the triangles upon the condition that a difference between normal vectors of the triangles is less than a predetermined angle.

3. The method as described in claim 2, wherein the predetermined angle is equal to thirty degrees.

4. The method as described in claim 2, wherein the step (a) comprises:
(a1) converting the 3D model to a B-spline curved surface, determining a closed boundary curve of the B-spline curved surface in a parametric plane, and dividing the closed boundary curve to obtain a plurality of grids using a plurality of horizontal lines and vertical lines;
(a2) if one of the grids has no intersection point with the closed boundary curve, generating two triangles by connecting four vertices of the grid anti-clockwise;
(a3) if one of the grids has one or more intersection points with the closed boundary curve, using the one or more intersection points, one or more vertices of the grid which fall within the closed boundary curve, and boundary points of the closed boundary line to form a 2D data structure;
(a4) reading a first point and a second point nearest to the first point from the 2D data structure, constructing one side of a triangle using the first point and the second point, and determining a third point of the triangle according to a determination rule, wherein the determination rule represents that there is no 2D point of the 2D data structure in a circumcircle of the triangle; and
(a5) determining vertices of other triangles in the 2D data structure according to the determination rule, to generate the plurality of triangles of the 3D model.

5. The method as described in claim 1, wherein the motion parameters comprise a range of rotation, a range of motion, and a step length of the probe.

6. The method as described in claim 5, wherein the range of rotation comprises a horizontal range and a vertical range, the horizontal range is between −180 degrees and +180 degrees, and the vertical range is between 0 degree and 105 degrees.

7. The method as described in claim 1, further comprising:
saving the component names in a second file according to the drawing order; and
saving the 3D model of the probe in the second file.

8. An electronic device for simulating a probe of a workpiece measuring device to measure a workpiece, the electronic device comprising:
at least one processor;
a storage system; and
one or more modules that are stored in the storage system and executed by the at least one processor, the one or more modules comprising:
a file creation module operable to correlate component names of the probe to a corresponding CAD modeling file;
a 3D model drawing module operable to read the CAD modeling files from a first file according to a drawing order of the probe, and draw a three-dimensional (3D) model of the probe according to the drawing order and the relative positions between each two components, the first file comprising specifications of components of the probe, the component names, file names of computer aided design (CAD) modeling files of the components, and relative positions between each two components;
a control module operable to read measurement points of the workpiece in a preset order, and save coordinate values of the measurement points in an array according to the preset order; and
the control module further operable to obtain a measurement path of the 3D model by controlling the 3D model to simulate the probe measuring the measurement points in the array according to predefined motion parameters, and display the measurement path on a display screen of the electronic device.

9. The electronic device as described in claim 8, wherein the 3D model drawing module is further operable to mesh the 3D model of the probe by a plurality of triangles, and merge the triangles upon the condition that a difference between normal vectors of the triangles is less than a predetermined angle.

10. The electronic device as described in claim 9, wherein the predetermined angle is equal to thirty degrees.

11. The electronic device as described in claim 9, wherein the triangulating the 3D model comprises:
(a1) converting the 3D model to a B-spline curved surface, determining a closed boundary curve of the B-spline curved surface in a parametric plane, and dividing the closed boundary curve to obtain a plurality of grids using a plurality of horizontal lines and vertical lines;
(a2) if one of the grids has no intersection point with the closed boundary curve, generating two triangles by connecting four vertices of the grid anti-clockwise;
(a3) if one of the grids has one or more intersection points with the closed boundary curve, using the one or more intersection points, one or more vertices of the grid which fall within the closed boundary curve, and boundary points of the closed boundary line to form a 2D data structure;
(a4) reading a first point and a second point nearest to the first point from the 2D data structure, constructing one side of a triangle using the first point and the second point, and determining a third point of the triangle according to a determination rule, wherein the determination rule represents that there is no 2D point of the 2D data structure in a circumcircle of the triangle; and
(a5) determining vertices of other triangles in the 2D data structure according to the determination rule, to generate the plurality of triangles of the 3D model.

12. The electronic device as described in claim 8, wherein the motion parameters comprise a range of rotation, a range of motion, and a step length of the probe.

13. The electronic device as described in claim 12, wherein the range of rotation comprises a horizontal range and a vertical range, the horizontal range is between −180 degrees and +180 degrees, and the vertical range is between 0 degree and 105 degrees.

14. The electronic device as described in claim 1, wherein the 3D model drawing module is further operable to save the component names in a second file according to the drawing order, and save the 3D model of the probe in the second file.

15. A non-transitory storage medium having stored thereon instructions that, when executed by a processor of an electronic device, causes the processor to perform a method for simulating a probe of a workpiece measuring device, the method comprising:
correlating component names of the probe to a corresponding CAD modeling file;
reading the CAD modeling files from a first file according to a drawing order of the probe, and drawing a three-dimensional (3D) model of the probe according to the drawing order and the relative positions between each two components, the first file comprising specifications of components of the probe, the component names, file names of computer aided design (CAD) modeling files of the components, and relative positions between each two components;
reading measurement points of the workpiece in a preset order, and saving coordinate values of the measurement points in an array according to the preset order;
obtaining a measurement path of the 3D model by controlling the 3D model to simulate the probe measuring the measurement points in the array according to predefined motion parameters; and
displaying the measurement path on a display screen of the electronic device.

16. The storage medium as described in claim 15, wherein the method further comprises steps before controlling the 3D model of the probe to simulate the probe measuring the measurement points:
(a) meshing the 3D model of the probe by a plurality of triangles; and
(b) merging the triangles upon the condition that a difference between normal vectors of the triangles is less than a predetermined angle.

17. The storage medium as described in claim 16, wherein the predetermined angle is equal to thirty degrees.

18. The storage medium as described in claim 16, wherein the step (a) comprises:
(a1) converting the 3D model to a B-spline curved surface, determining a closed boundary curve of the B-spline curved surface in a parametric plane, and dividing the closed boundary curve to obtain a plurality of grids using a plurality of horizontal lines and vertical lines;
(a2) if one of the grids has no intersection point with the closed boundary curve, generating two triangles by connecting four vertices of the grid anti-clockwise;
(a3) if one of the grids has one or more intersection points with the closed boundary curve, using the one or more intersection points, one or more vertices of the grid which fall within the closed boundary curve, and boundary points of the closed boundary line to form a 2D data structure;
(a4) reading a first point and a second point nearest to the first point from the 2D data structure, constructing one side of a triangle using the first point and the second point, and determining a third point of the triangle according to a determination rule, wherein the determination rule represents that there is no 2D point of the 2D data structure in a circumcircle of the triangle; and
(a5) determining vertices of other triangles in the 2D data structure according to the determination rule, to generate the plurality of triangles of the 3D model.

19. The storage medium as described in claim 15, wherein the motion parameters comprise a range of rotation, a range of motion, and a step length of the probe.

20. The storage medium as described in claim 19, wherein the range of rotation comprises a horizontal range and a vertical range, the horizontal range is between −180 degrees and +180 degrees, and the vertical range is between 0 degree and 105 degrees.
